(19) United States
(12) Patent Application Publication
(10) Pub. No.: US 2025/0272233 A1
(43) Pub. Date: Aug. 28, 2025

(54) STORAGE DEVICE, OPERATION METHOD THEREOF AND SYSTEM INCLUDING THE SAME

(71) Applicant: SAMSUNG ELECTRONICS CO., LTD., Suwon-si (KR)

(72) Inventors: Jongin Lee, Suwon-si (KR); Sang-Hwa Jin, Suwon-si (KR)

(73) Assignee: SAMSUNG ELECTRONICS CO., LTD., Suwon-si (KR)

(21) Appl. No.: 18/937,814

(22) Filed: Nov. 5, 2024

(30) Foreign Application Priority Data
Feb. 28, 2024 (KR) 10-2024-0028675

(51) Int. Cl. G06F 12/02

(52) U.S. Cl. CPC G06F 12/0246

(57) ABSTRACT

A method of operating a storage device including a first storage controller and a controller manager is provided. The method includes receiving a first command from a first host through a first port connected to the first storage controller configured to store data of the first host, receiving first information associated with the first command from the first host through a second port connected to the controller manager configured to manage the first storage controller, determining a priority of the first command among a plurality of commands, and executing the first command based on the priority.

### CROSS-REFERENCE TO RELATED APPLICATIONS

This application claims priority under 35 U.S.C. §119 to Korean Patent Application No. 10-2024-0028675 filed on Feb. 28, 2024, in the Korean Intellectual Property Office, the disclosures of which are incorporated by reference herein in their entireties.

### BACKGROUND

Embodiments of the present disclosure described herein relate to a semiconductor device, and more particularly, relate to a storage device and a method of operating the storage device.

Various storage devices such solid-state devices (SSDs) are used to store data. While a single host may store data on one storage device, there is a widespread use of shared storage devices in which multiple hosts store data on the same storage device.

In the case of shared storage devices, certain commands issued by some hosts may need to be processed urgently by the storage device. For example, in a shared storage device of a vehicle, data required for urgent control of the vehicle may need to be provided to the host within a short time frame. Therefore, there is a need for a device and a method that ensures the latency of commands issued by the host is guaranteed by the storage device.

### SUMMARY

Embodiments of the present disclosure provide a storage device that may process a latency sensitive command in compliance with a set latency in a shared storage device, a system including the storage device, and a method of operating the same.

According to an aspect of the present disclosure, a method of operating a storage device including a first storage controller and a controller manager, may include: receiving a first command from a first host through a first port connected to the first storage controller configured to store data of the first host; receiving first information associated with the first command from the first host through a second port connected to the controller manager configured to manage the first storage controller; determining a priority of the first command among a plurality of commands; and executing the first command based on the priority.

According to another aspect of the present disclosure, a method of operating a host configured to store data in a storage device, may include: writing a first command into a submission queue; transmitting the first command to the storage device through a first port; transmitting first information associated with the first command to the storage device through a second port; receiving a first execution result of the first command from the storage device; receiving second information associated with the first execution result from the storage device through the second port; and processing the first execution result based on the second information, wherein the second port may be connected to a controller manager configured to manage at least one storage controller in the storage device.

According to another aspect of the present disclosure, a storage device configured to store data of at least one host, may include: at least one non-volatile memory device configured to store data; at least one storage controller configured to control the at least one non-volatile memory device and receive a first command and data from a first host through a first port; and a controller manager configured to manage the storage controller and receive first information associated with the first command through a second port.

According to another aspect of the present disclosure, an automotive control system may include: a first electronic control unit (ECU) configured to control a vehicle; a second ECU configured to control the vehicle; and a storage device configured to store data of the first ECU and the second ECU, wherein the storage device may include: a non-volatile memory device configured to store data; a first storage controller configured to store the data of the first ECU in the non-volatile memory device; a second storage controller configured to store the data of the second ECU in the non-volatile memory device; and a controller manager configured to manage the first storage controller and the second storage controller, and wherein the first ECU may be further configured to transmit a first command to the first storage controller through a first port, and transmit first information associated with the first command to the controller manager through a second port.

### BRIEF DESCRIPTION OF DRAWINGS

The above and/or other aspects will become more apparent by describing in certain embodiments, with reference to the accompanying drawings.

FIG. 1 is a block diagram illustrating a storage system, according to one or more embodiments of the present disclosure.

FIG. 2 is a block diagram illustrating a host of FIG. 1 in detail, according to one or more embodiments of the present disclosure.

FIG. 3 is a block diagram illustrating a storage controller of FIG. 1 in detail, according to one or more embodiments of the present disclosure.

FIG. 4 is a block diagram illustrating an example of a method of operating a host and a storage device of FIG. 1, according to one or more embodiments of the present disclosure.

FIG. 5 is a flowchart illustrating a method of operating a storage system of FIG. 1 to ensure a command latency, according to one or more embodiments of the present disclosure.

FIG. 6 is a flowchart illustrating a method of operating a storage system of FIG. 1 to ensure a command latency, according to one or more embodiments of the present disclosure.

FIG. 7 is a block diagram illustrating a command management block of FIG. 3 in detail, according to one or more embodiments of the present disclosure.

FIG. 8 is a block diagram illustrating how a command management block of FIG. 7 operates, according to one or more embodiments of the present disclosure.

FIG. 9 is a block diagram illustrating an automotive system 2000, according to one or more embodiments of the present disclosure.

FIG. 10 is a block diagram illustrating an electronic system, according to one or more embodiments of the present disclosure.

### DETAILED DESCRIPTION

Hereinafter, embodiments of the present disclosure will be described in detail and clearly to such an extent that an ordinary one in the art easily implements the present disclosure.

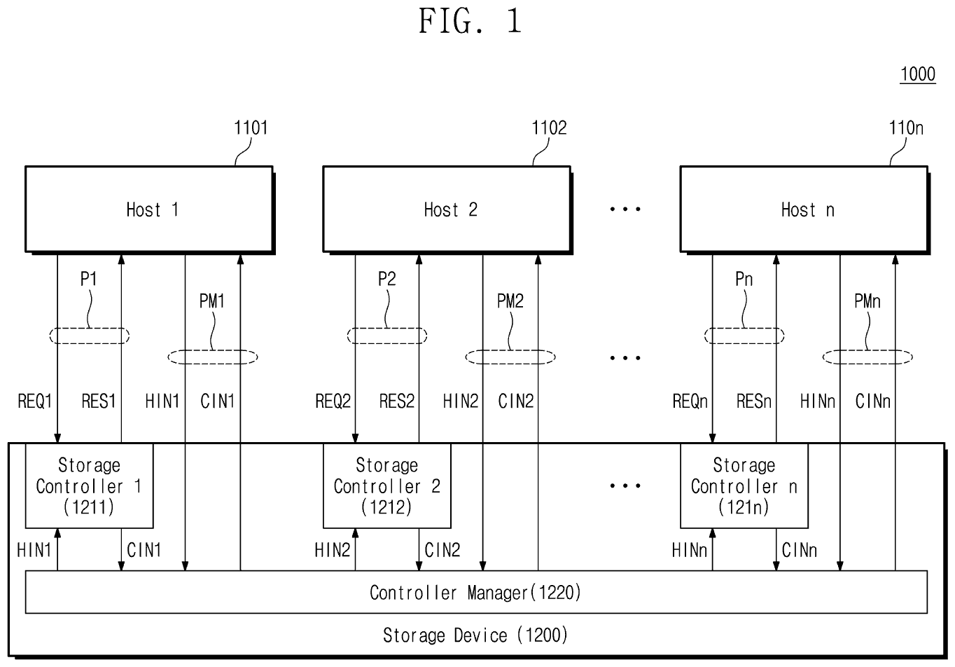

FIG. 1 is a block diagram illustrating a storage system, according to one or more embodiments of the present disclosure. Referring to FIG. 1, a storage system 1000 may include first to n-th hosts 1101 to 110n and a storage device 1200. The storage device 1200 may include first to n-th storage controllers 1211 to 121n and a controller manager 1220.

The storage system 1000 may store data, may manage the stored data, and may provide necessary information to a user. In one or more embodiments, the storage system 1000 may be included in a personal computer (PC), a laptop computer, a tablet PC, a personal digital assistant (PDA), a wearable device, a camera, an electronic device, or an automotive system. In another embodiment, the storage system 1000 may be a data center that stores various data, or may be a storage server or an application server included in the data center. However, these are an example, and the storage system 1000 is not limited to being included in the above-described devices.

Each of the first to n-th hosts 1101 to 110n may exchange data with the storage device 1200. In this case, ‘n’ may indicate the number of first to n-th hosts 1101 to 110n included in the storage system 1000. Each of the first to n-th hosts 1101 to 110n may independently access the storage device 1200. In one or more embodiments, the first to n-th hosts 1101 to 110n may be computing nodes configured to operate independently from each other.

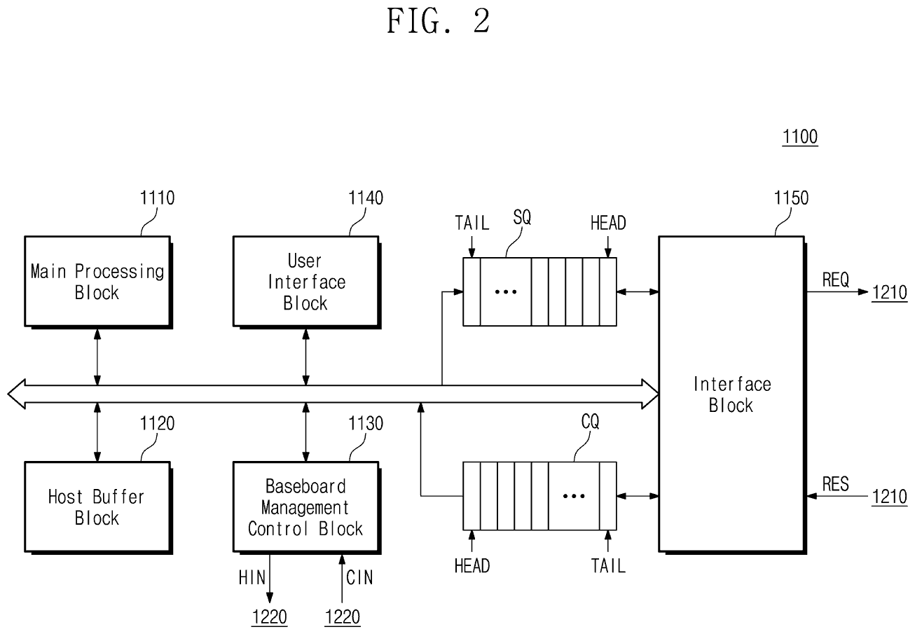

The first to n-th hosts 1101 to 110n may be single-core processors or multi-core processors included in different computing nodes (or computing systems). Alternatively, at least some of the first to n-th hosts 1101 to 110n may be different processors included in the same computing node (or the computing system). The detailed structure of each of the first to n-th hosts 1101 to 110n will be described in more detail with reference to FIG. 2.

Each of the first to n-th hosts 1101 to 110n may control the storage device 1200 and may generate data to be stored in the storage device 1200. Each of the first to n-th hosts 1101 to 110n may read data from the storage device 1200 and may execute various programs or software based on the read data to perform operations.

The first to n-th hosts 1101 to 110n may transmit requests REQ1 to REQn to the storage device 1200, respectively. The storage device 1200 may transmit responses RES1 to RESn corresponding to the requests RES1 to RESn to the first to n-th hosts 1101 to 110n, respectively. The first to n-th hosts 1101 to 110n may correspond to or be assigned to at least one of the first to n-th storage controllers 1211 to 121n. In one or more embodiments, the first to n-th hosts 1101 to 110n and the first to n-th storage controllers 1211 to 121n may correspond one-to-one. For example, the first host 1101 may correspond to the first storage controller 1211, and the second host 1102 may correspond to the second storage controller 1212.

However, these are provided as examples. A configuration in which a plurality of hosts are assigned to one storage controller may also fall within the scope of embodiments of the present disclosure. For example, all of the first to n-th hosts 1101 to 110n may be assigned to one storage controller.

The requests REQ1 to REQn or the responses RES1 to RESn may include a command or data. In one or more embodiments, the first to n-th hosts 1101 to 110n and the storage device 1200 may operate depending on the non-volatile memory express protocol (NVMe protocol). For example, the first to n-th hosts 1101 to 110n may exchange data or commands with the corresponding first to n-th storage controllers 1211 to 121n according to the NVMe standard. In particular, the requests REQ1 to REQn or the responses RES1 to RESn may be received or transmitted between the first to n-th hosts 1101 to 110n and the first to n-th storage controllers 1211 to 121n through an interface that complies with a PCIe standard.

In one or more embodiments, the first to n-th hosts 1101 to 110n and the first to n-th storage controllers 1211 to 121n are assigned to ports of at least one interface to exchange the requests REQ1 to REQn and the responses RES1 to RESn. For example, the first host 1101 may exchange the first request REQ1 or the first response RES1 with the corresponding first storage controller 1211 through a first port P1 of a peripheral component interface express (PCIe) interface. For another example, the second host 1102 may exchange the second request REQ2 or the second response RES2 with the corresponding second storage controller 1212 through a second port P2 of the PCIe interface.

The first to n-th hosts 1101 to 110n may transmit first to n-th host management information HIN1 to HINn to the controller manager 1220, and may receive first to n-th controller management information CIN1 to CINn from the controller manager 1220. In one or more embodiments, communication between the first to n-th hosts 1101 to 110n and the controller manager 1220 may be performed based on a non-volatile memory express management interface (NVMe-MI) protocol. Communication between the first to n-th hosts 1101 to 110n and the controller manager 1220 may be performed through a side-band interface of a standard such as the PCIe, a system management bus (SMBUS), or an inter integrated circuit (I2C).

Each of the first to n-th host management information HIN1 to HINn may include host information and command information of a command issued by the host. For example, the first host management information HIN1 may include host information of the first host 1101 and command information of a command issued by the first host 1101. In one or more embodiments, each of the first to n-th host management information HIN1 to HINn may include command information of a latency sensitive command issued by the first to n-th hosts 1101 to 110n.

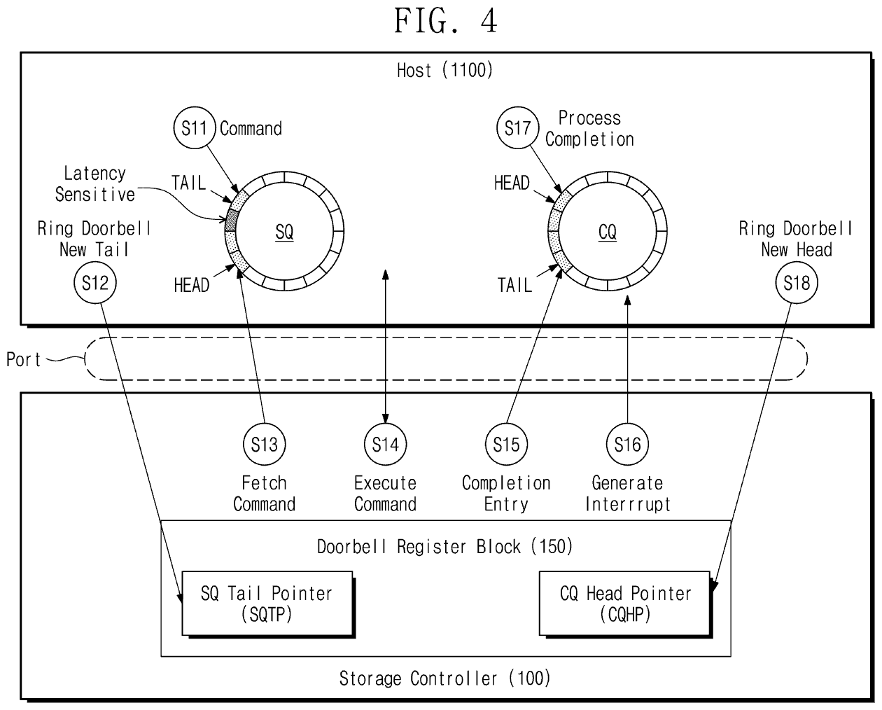

The latency sensitive command may be a command that requires a latency to be guaranteed (or strictly guaranteed). The latency may be the time from when the host issues a command until the host processes execution results of the storage device. The latency and the latency sensitive command will be described in more detail with reference to FIG. 4.

Each of the first to n-th controller management information CIN1 to CINn may include controller status information and executed command information for each of the first to n-th storage controllers 1211 to 121n. In one or more embodiments, each of the first to n-th controller management information CIN1 to CINn may include information about the latency sensitive command processed by the first to n-th storage controllers 1211 to 121n. The controller status information may include performance of the storage controller, a power consumption amount of the storage controller, or a status of the storage controller. The controller status information may be used to provide stability of operation of the storage controller.

In one or more embodiments, the first to n-th hosts 1101 to 110n and the controller manager 1220 are assigned to ports of at least one interface and may exchange the host management information and the controller management information. For example, the first host 1101 may be assigned to a first management port PM1, and may transmit the first host management information HIN1 to the controller manager 1220, or may receive the first controller management information CIN1 from the controller manager 1220. The second host 1102 may be assigned to a second management port PM2, and may transmit the second host management information HIN2 to the controller manager 1220, or may receive the second controller management information CIN2 from the controller manager 1220.

In another embodiment, at least some of the first to n-th hosts 1101 to 110n may share an interface port. In FIG. 1, all of the first to n-th hosts 1101 to 110n are illustrated and described as being connected to the controller manager 1220, but the scope of the present disclosure is not limited thereto. In one or more embodiments, some of the first to n-th hosts 1101 to 110n may not be connected to the controller manager 1220.

The storage device 1200 may store data received from the first to n-th hosts 1101 to 110n, and may provide the stored data to the first to n-th hosts 1101 to 110n. In one or more embodiments, the storage device 1200 may be a single storage device or a storage device configured to support multi-hosts. In one or more embodiments, the storage device 1200 may be a shared storage device. For example, referring to FIG. 1, the first to n-th hosts 1101 to 110n may share the storage device 1200.

The storage device 1200 may include at least one non-volatile memory device, such as a NAND flash memory. Embodiments in which the storage device 1200 includes various non-volatile memory devices, such as a magnetic random access memory (MRAM) or a ferroelectric random access memory (FeRAM), should also be understood to fall within the scope of embodiments of the present disclosure.

The first to n-th storage controllers 1211 to 121n may control the overall operation of the storage device 1200. The first to n-th storage controllers 1211 to 121n may receive the requests from the corresponding (or assigned) first to n-th hosts 1101 to 110n, or may transmit the responses to the first to n-th hosts 1101 to 110n. For example, the first storage controller 1211 may receive the first request REQ1 from the first host 1101 or may transmit the first response RES1 to the first host 1101.

The first to n-th storage controllers 1211 to 121n may store data received from the host in at least one non-volatile memory device. The first to n-th storage controllers 1211 to 121n may read data stored in at least one non-volatile memory device and may transmit the read data to the corresponding host of the first to n-th hosts 1101 to 110n. In one or more embodiments, some of the first to n-th storage controllers 1211 to 121n may share the non-volatile memory device.

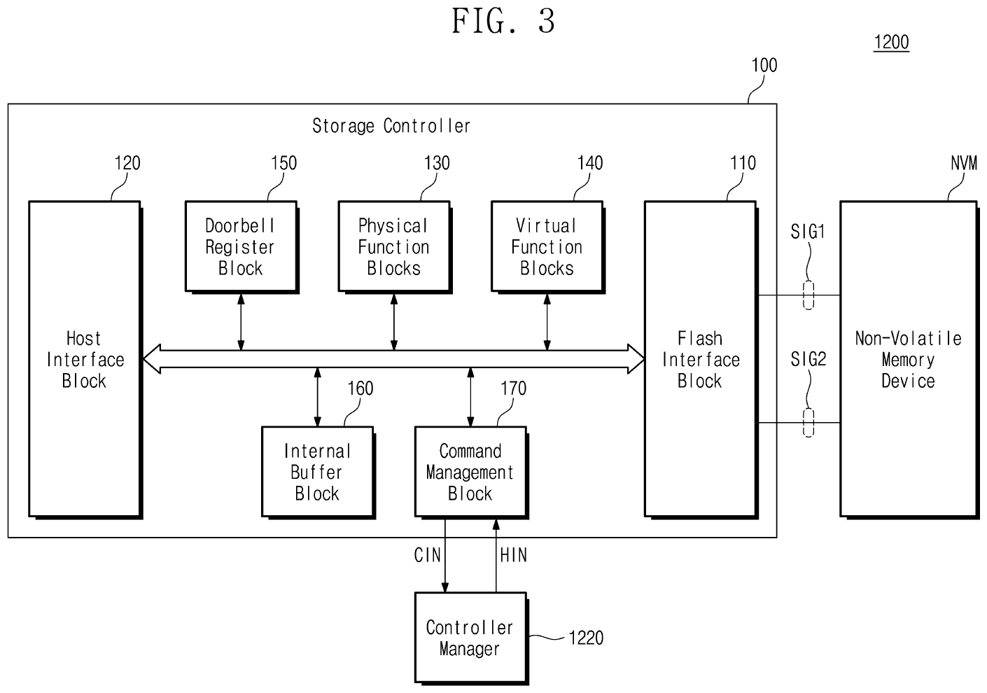

In FIG. 1, although the first to n-th storage controllers 1211 to 121n are illustrated as having a one-to-one correspondence with the first to n-th hosts 1101 to 110n, but the scope of the present disclosure is not limited thereto. It should be understood that a configuration in which some of the first to n-th storage controllers 1211 to 121n are assigned to the same host may also fall within the scope of embodiments of the present disclosure. The detailed structure of each of the first to n-th storage controllers 1211 to 121n will be described in more detail with reference to FIG. 3.

The controller manager 1220 may manage the first to n-th storage controllers 1211 to 121n. In one or more embodiments, the controller manager 1220 may receive the first to n-th controller management information CIN1 to CINn including respective controller status information from the first to n-th storage controllers 1211 to 121n. The controller manager 1220 may manage the first to n-th storage controllers 1210 to 121n based on the received controller status information. For example, the controller manager 1220 may manage the first to n-th storage controllers 1210 to 121n based on the control of the host that receives the controller status information.

The controller manager 1220 may receive the first to n-th host management information HIN1 to HINn from the first to n-th hosts 1101 to 110n, and may transmit the received host management information to the corresponding first to n-th storage controllers 1211 to 121n. For example, the controller manager 1220 may receive the first host management information HIN1 from the first host 1101, and may transmit the received first host management information HIN1 to the first storage controller 1211. The controller manager 1220 may receive the first to n-th controller management information CIN1 to CINn from the first to n-th storage controllers 1211 to 121n, and may transmit the received first to n-th controller management information CIN1 to CINn to the corresponding host.

In FIG. 1, the management ports PM1 to PMn of the interface connected to the controller manager 1220 are illustrated as being independently assigned to each of the first to n-th hosts 1101 to 110n, but embodiments of the present application are not limited thereto. In addition, although the controller manager 1220 is described as being connected to all of the first to n-th hosts 1101 to 110n, some of the hosts may not be connected to the controller manager 1220. In one or more embodiments, the controller manager 1220 may not be connected to the storage controller corresponding to some of the first to n-th hosts 1101 to 110n that are not connected.

FIG. 2 is a block diagram illustrating a host 1100, according to one or more embodiments of the present disclosure. The host 1100 of FIG. 2 may correspond to any one of the first to n-th hosts 1101 to 110n of FIG. 1. Referring to FIG. 2, the host 1100 may include a main processing block 1110, a host buffer block 1120, a baseboard management control block 1130, a user interface block 1140, an interface block 1150, a submission queue SQ, and a completion queue CQ. The submission queue SQ and the completion queue CQ may be data structures in memory (e.g., a random access memory). With reference to FIG. 2, the host 1100 according to one or more embodiments of the present disclosure is described in detail.

The main processing block 1110 may control the overall operation of the host 1100. In one or more embodiments, the main processing block 1110 may execute various programs, applications, or software to enable the host 1100 to perform various operations. In one or more embodiments, the main processing block 1110 may include various processors or various processing units. For example, the main processing block 1110 may include various processing units, such as a central processing unit (CPU), a neural processing unit (NPU), or a graphics processing unit (GPU). The main processing block 1110 may generate data to be stored in the storage device 1200 of FIG. 1 or may use data read from the storage device 1200.

In one or more embodiments, the processing units included in the main processing block 1110 may be single-core processors or multi-core processors. For example, the CPU included in the main processing block 1110 may be a multi-core processor. In one or more embodiments, cores of a processing unit included in the main processing block 1110 may operate independently or in conjunction with each other. In one or more embodiments, each core of the processing unit may be assigned to a physical function block or a virtual function block of FIG. 3, which will be described later.

The host buffer block 1120 may store data required for operation of the host 1100. In one or more embodiments, the host buffer block 1120 may store data required for the operation of the main processing block 1110. For example, the host buffer block 1120 may store a source code of the program or application to be executed by the main processing block 1110, data used by an application to run or a processing unit to operate, or data to be stored in the storage device 1200 of FIG. 1.

In one or more embodiments, the host buffer block 1120 may include various types of memory or may be a memory. For example, the host buffer block 1120 may include or be a volatile memory, such as a static random access memory (SRAM), a dynamic random access memory (DRAM), or a high bandwidth memory (HBM).

The baseboard management control block 1130 may control and manage

various devices connected to the host 1100. For example, the baseboard management control block 1130 may manage the storage device 1200 of FIG. 1. In one or more embodiments, the baseboard management control block 1130 may be connected to and communicate with a controller manager 1220 of FIG. 1. For example, the baseboard management control block 1130 may transmit host management information HIN to the controller manager 1220, or may receive controller management information CIN from the controller manager 1220.

The host management information HIN may correspond to any one of the first to n-th host management information HIN1 to HINn in FIG. 1, and the controller management information CIN may correspond to any one of the first to n-th controller management information CIN1 to CINn in FIG. 1. In one or more embodiments, the baseboard management control block 1130 may transmit a signal for controlling the storage controller 1210 to the controller manager 1220 based on the controller status information included in the received controller management information CIN. The storage controller 1210 may correspond to any one of the first to n-th storage controllers 1211 to 121n in FIG. 1.

The host management information HIN may include command information about all or some of the commands issued by the host 1100. The command information may include information about a command ID or a command latency limitation. In one or more embodiments, the host management information HIN may include command information of a command that is sensitive to latency. For example, the host management information HIN may include the command ID of the latency sensitive command, information on the host that issues the corresponding command, a time of issuing the corresponding command, or the latency limitation of the corresponding command. In one or more embodiments, when the host 1100 issues the latency sensitive command, the baseboard management control block 1130 may transmit the host management information HIN containing the command information of the latency sensitive command to the command manager 1220.

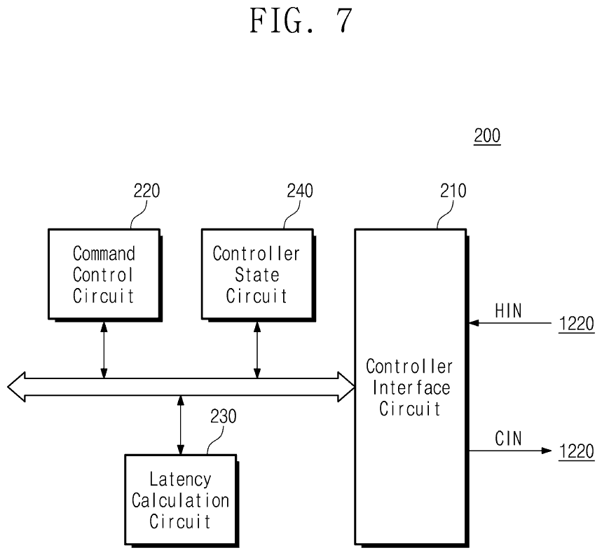

The controller management information CIN may include status information of the storage controller 1210 or command information of commands executed by the storage controller 1210. The command information may include a command ID, a command remaining latency, etc. The remaining latency may refer to the amount of time left before a latency-sensitive task must be completed. The remaining latency may be a duration from the current moment until the deadline by which a command or operation needs to be finished to meet its latency requirement. In one or more embodiments, the controller management information CIN may include command information associated with the latency sensitive command. The controller management information CIN will be described in more detail with reference to FIG. 7.

The user interface block 1140 may receive data or information of the host 1100 from a user or may provide it to the user. In one or more embodiments, the user interface block 1140 may receive various interrupts. For example, the user interface block 1140 may be connected to a keyboard, a touchpad, or a microphone to receive interrupts or data. In one or more embodiments, the user interface block 1140 may allow the operation results of the host 1100 to be provided to the user as visual or auditory data.

The interface block 1150 may enable communication between the host 1100 and the storage controller 1210. In one or more embodiments, the host 1100 may transmit a request REQ to the storage controller 1210 through the interface block 1150. The host 1100 may receive a response RES from the storage controller 1210 through the interface block 1150. The interface block 1150 may enable communication between the host 1100 and the storage controller 1210 depending on an interface standard. For example, the interface block 1150 may enable communication between the host 1100 and the storage controller 1210 depending on the PCIe standard.

The submission queue SQ may be a queue containing commands to be transmitted to the storage device 1200. In one or more embodiments, the submission queue SQ may transmit a command to the storage device 1200 according to a first in first out manner. For example, the submission queue SQ may write a command generated by the operation of the main processing block 1110 into a tail TAIL of the submission queue SQ, following a first-in-first-out (FIFO) order. Similarly, a command located at a head HEAD of the submission queue SQ may be transmitted to the storage controller 100 through the interface block 1150, so that commands are processed in the order they were received. The submission queue SQ of FIG. 2 is illustrated and described in the form of a general queue, but may be implemented in the form of any type of queue. In one or more embodiments, the submission queue SQ may be implemented as a circular queue.

In one or more embodiments, the submission queue SQ may be a priority queue, and the host 1100 may manage a priority. The priority queue may add elements (e.g., commands) with an associated priority, and may remove the element with the highest priority first. If two elements have the same priority, they may be processed in the order they arrived, while this varies depending on a specific implementation. For example, the host 1100 may write commands generated by the main processing block 1110 into the submission queue SQ based on the priority determined or adjusted according to the latency limitation of the commands. Information about the latency limitation of the commands may be included in the host management information HIN. The priority may be the order in which data are accessed by the storage device 1200. That is, when the host 1100 includes a priority queue or a submission queue SQ implemented as the priority queue, the host 1100 may manage the priority of elements in the submission queue SQ such that the latency of all or some of issued commands may be guaranteed. In this case, the storage device 1200 may sequentially fetch commands according to priority.

The completion queue CQ may be a queue containing data received from the storage device 1200. In one or more embodiments, the completion queue CQ may receive data from the storage device 1200 according to the first in first out manner. In one or more embodiments, the completion queue CQ may receive command execution results from the storage device 1200 according to the first in first out manner. For example, the completion queue CQ may write the execution result generated by the operation of the storage device 1200 in the tail TAIL of the completion queue CQ. The execution result located at the head of the completion queue CQ may be processed by the host 1100 (e.g., the main processing block 1110). The completion queue CQ of FIG. 2 is illustrated and described in the form of a general queue, but may be implemented in the form of any type of queue. In one or more embodiments, the completion queue CQ may be implemented as a circular queue.

In one or more embodiments, the completion queue CQ may be implemented as a priority queue, and the host 1100 may manage the priority. For example, the host 1100 may determine the priority for processing data (e.g., command execution results of the storage device 1200) in the completion queue CQ based on the controller command information CIN received by the baseboard management control block 1130. For a more detailed example, the host 1100 may change or adjust the priority such that the execution results of the latency sensitive command written to the completion queue CQ may comply with the latency limitation. The completion queue CQ may add commands with an associated priority, and may remove the command with the highest priority first. If two commands have the same priority, they may be processed in the order they arrived, while this varies depending on a specific implementation. When the host 1100 includes a priority queue or the completion queue CQ implemented as the priority queue, the host 1100 may manage the priority of the completion queue CQ such that the latency of all or some of issued commands may be guaranteed. In this case, the storage device 1200 may sequentially process command execution results depending on the priority.

In one or more embodiments, the host 1100 may manage one of the submission queue SQ and the completion queue CQ as the priority queue. In another embodiment, the host 1100 may manage both the submission queue SQ and the completion queue CQ as the priority queues. The host 1100 may include the submission queue SQ and the completion queue CQ of an appropriate structure to guarantee the latency of issued commands, and may guarantee the latency of commands based on the above-described operation. Although the priority queue is described with an example structure of the submission queue SQ and the completion queue CQ, the scope of the present disclosure is not limited thereto. In one or more embodiments, the submission queue SQ or the completion queue CQ may be any data structure capable of managing the priority of a list of commands or execution results, or may include any data structure to ensure the latency of commands.

Each block of the host 1100 of FIG. 2 may be functionally divided and may be implemented with various hardware structures. In one or more embodiments, the main processing block 1110 and the baseboard management control block 1130 may be implemented to be included in a same hardware structure (e.g., a single processor, a single CPU, or a single electronic control unit (ECU)) or multiple different hardware structures (e.g., any combination of multiple processors, multiple CPUs, or multiple ECUs). The main processing block 1110 and the baseboard management block may be implemented as one piece of hardware. For example, the host 1100 may include any processor, an application-specific integrated circuit (ASIC), or a field programmable gate arrays (FPGA) configured to perform the operations of the main processing block 1110 and the baseboard management control block 1130. In one or more embodiments, the host buffer block 1120, the submission queue SQ, and the completion queue CQ may be implemented with any type of memory device. Some or all of the host buffer block 1120, the submission queue SQ, or the completion queue CQ may be implemented with a single memory device or multiple memory devices. For example, a volatile memory such as SRAM or DRAM, or a non-volatile memory may be provided to perform the functions of the host buffer block 1120, the submission queue SQ, and the completion queue CQ.

The host 1100 illustrated and described with reference to FIG. 2 is an example and the scope of the present disclosure is not limited thereto. In one or more embodiments, the host 1100 may not include some of the configurations illustrated in FIG. 2. For example, the host 1100 may not include the baseboard management control block 1130. In this case, the host 1100 may receive and utilize the controller management information CIN through the interface block 1150.

In one or more embodiments, the host 1100 may support virtual machines and may further include a hypervisor capable of managing and controlling them. For example, the host 1100 may implement the hypervisor through the main processing block 1110, may configure at least one virtual machine, or allow the virtual machine to operate.

FIG. 3 is a block diagram illustrating the storage device 1200 of FIG. 1 in detail, according to one or more embodiments of the present disclosure. Referring to FIG. 3, the storage device 1200 may include a storage controller 100, the controller manager 1220, and a non-volatile memory device NVM. With reference to FIG. 3, the storage device 1200 according to one or more embodiments of the present disclosure is described. FIG. 3 illustrates an example in which the storage device 1200 includes one storage controller. However, one or more embodiments in which the storage device 1200 further includes a storage controller identical to or similar to the storage controller 100 illustrated in FIG. 3 should also be understood as falling within the scope of the present disclosure.

The non-volatile memory device NVM may store data of the storage device 1200. The non-volatile memory device NVM may be a NAND flash memory device, but embodiments of the present disclosure are not limited thereto. The non-volatile memory device NVM may communicate with the storage controller 100 through two signal lines.

In one or more embodiments, the non-volatile memory device NVM may be connected to the storage controller 100 through a first signal line SIG1 and a second signal line SIG2. For example, the non-volatile memory device NVM may receive a command or an address from the storage controller 100 through the first signal line SIG1 and may exchange data with the storage controller 100. For another example, the non-volatile memory device NVM may receive a control signal from the storage controller 100 through the second signal line SIG2.

FIG. 3 illustrates that the storage controller 100 is connected to one non-volatile memory device NVM, but embodiments are not limited thereto. For example, the storage controller 100 may be connected to a plurality of non-volatile memory devices. In this case, the storage controller 100 may control the non-volatile memory devices through common first and second signal lines of the plurality of non-volatile memory devices, or may control each of the non-volatile memory devices through the first signal line and the second signal line of each of the non-volatile memory devices. Alternatively, the storage controller 100 may control at least some of the plurality of nonvolatile memory devices through the common first signal line and the common second signal line.

The storage controller 100 may correspond to any one of the storage controllers 1210 to 121n in FIG. 1. Referring to FIG. 3, the storage controller 100 may include a flash interface block 110, a host interface block 120, physical function blocks 130, virtual function blocks 140, a doorbell register block 150, an internal buffer block 160, and a command management block 170. With reference to FIGS. 2 and 3, the storage controller 100 according to one or more embodiments of the present disclosure is described in detail.

In one or more embodiments, the blocks of the storage controller 100 illustrated and described with reference to FIG. 3 may be functionally divided, and each of the plurality of blocks may be implemented with various hardware structures, or may be implemented with any hardware(s) configured to perform the functions of a plurality of blocks. For example, the storage controller 100 may include any hardware, firmware, or processor that performs the later-described operations of the physical function blocks 130, the virtual function blocks 140, or the command management block 170. As another example, the storage controller 100 may include any memory (e.g., a volatile memory or a non-volatile memory) configured to perform the later-described operations of the doorbell register block 150 or the internal buffer block 160.

The flash interface block 110 may perform communication between the non-volatile memory device NVM and the storage controller 100. In one or more embodiments, the flash interface block 110 may allow various signals (e.g., commands, addresses, or data) of the storage controller 100 to be transferred to the non-volatile memory device NVM through the first signal line SIG1 and the second signal line SIG2. The flash interface block 110 may receive data read from the non-volatile memory device NVM through the first signal line SIG1.

The host interface block 120 may perform communication between the storage controller 100 and the host 1100 of FIG. 2. For example, the host interface block 120 may receive the request from the host 1100 or may transmit the response to the host 1100. In one or more embodiments, the host interface block 120 may comply with the NVMe standard to enable communication between the storage controller 100 and the host 1100. For example, the host interface block 120 may meet PCIe standard specifications.

The physical function blocks 130 and the virtual function blocks 140 may allow the storage controller 100 to perform operations corresponding to various requests received from the host 1100. In one or more embodiments, each of the physical function blocks 130 may be assigned for each host. In another embodiment, the physical function blocks 130 may be assigned to a physical core of the host 1100, and the virtual function blocks 140 may be assigned to a virtual machine of the host 1100. For example, when the storage controller 1200 is assigned to a plurality of hosts, each of the physical function blocks 130 may be assigned for each host or for each physical core of each host. In one or more embodiments, the physical function blocks 130 and the virtual function blocks 140 may fetch and execute a command issued by the corresponding host, and may allow the storage device 1200 to perform the operation indicated by the command.

The physical function blocks 130 and the virtual function blocks 140 may be components classified according to operation or function. For example, the physical function blocks 130 and the virtual function blocks 140 may be implemented through firmware of the storage controller 100. In one or more embodiments, the physical function blocks 130 and the virtual function blocks 140 may be implemented by any processor included in the storage controller 100.

The doorbell register block 150 may store pointer information of the submission queue SQ or the completion queue CQ of the host 1100. In one or more embodiments, the doorbell register block 150 may store a pointer of the tail TAIL of the submission queue SQ in the host 1100. In detail, the storage controller 100 may recognize that the host 1100 issues a new command based on that the pointer of the tail TAIL of the submission queue SQ stored in the doorbell register block 150 is updated. In another embodiment, the doorbell register block 150 may store a pointer of the head HEAD of the completion queue CQ of FIG. 2 where the storage controller 100 completes an operation according to the response RES. In detail, the storage controller 100 may recognize that the host 1100 processes the response RES transmitted by the storage controller 100 based on that the pointer of the head HEAD of the completion queue CQ stored in the doorbell register block 150 is updated.

The internal buffer block 160 may store data required for the operation of the storage controller 100. In one or more embodiments, the internal buffer block 160 may be a memory or include a memory. For example, the internal buffer block 160 may be or include a volatile memory, such as a static random access memory (SRAM) or a dynamic random access memory (DRAM). The internal buffer block 160 may store data to be written into the non-volatile memory device NVM after receiving from the host 1100, or may store data to be transmitted to the host 1100 after reading from the non-volatile memory device NVM.

In one or more embodiments, the internal buffer block 160 may provide a space to manage commands received from the host 1100. For example, the storage controller 100 may receive a plurality of commands from the submission queue SQ through the host interface block 120 and may store the received commands into the internal buffer block 160. In one or more embodiments, the internal buffer block 160 may store the plurality of commands, including the execution order of commands in the submission queue SQ. For example, the internal buffer block 160 may include a queue (e.g., a general queue, a circular queue, or a priority queue) to store the plurality of commands. In another embodiment, the internal buffer block 160 may store the plurality of commands and allow the command management block 170 to access the plurality of commands to determine priorities among the commands.

The command management block 170 may determine the order in which the storage controller 100 executes the plurality of commands. For example, the command management block 170 may determine the order in which the plurality of commands stored in the internal buffer block 160 will be executed. In one or more embodiments, the command management block 170 may determine the priority among the plurality of commands based on the host management information HIN. For example, the command management block 170 may determine the priority of commands such that the latency of the latency sensitive command among the plurality of commands may be guaranteed, based on the command information of the latency sensitive command included in the host management information HIN. For a more detailed example, the command management block 170 may adjust or determine the priority of the plurality of commands by modifying the priority of the priority queue of the plurality of commands stored in the internal buffer block 160.

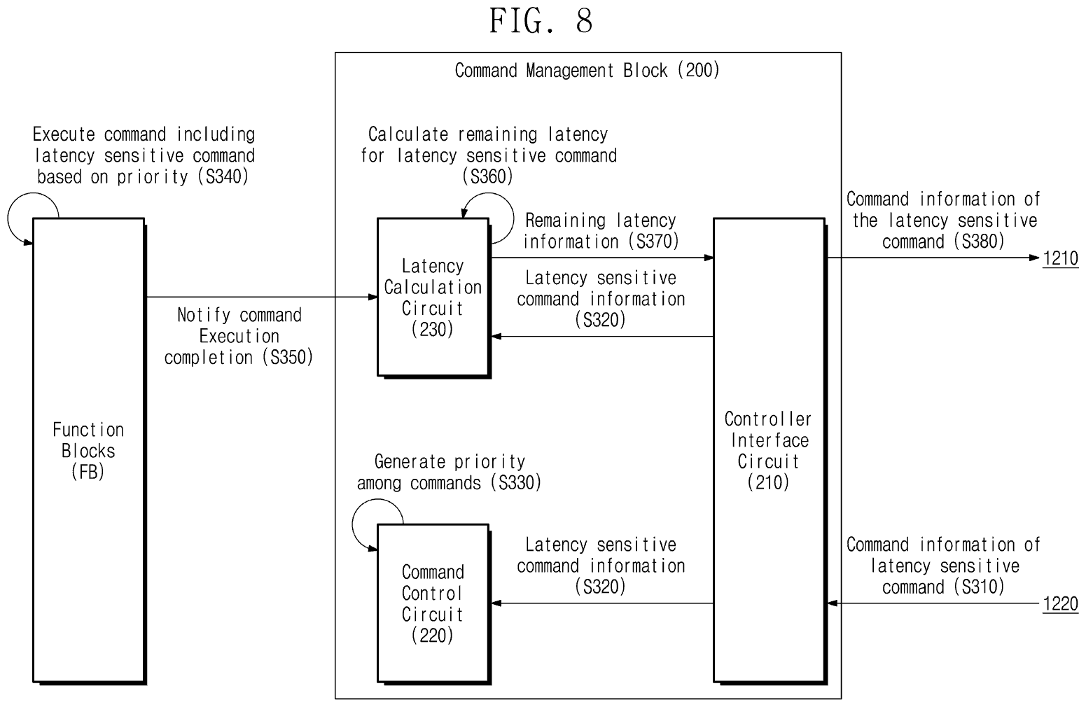

The command management block 170 may cause commands to be executed by the physical function blocks 130 or the virtual function blocks 140 depending on the determined priority of the commands, and may cause the storage device 1200 may perform the operation indicated by the commands. The command management block 170 may generate the controller management information CIN. In one or more embodiments, the controller management information CIN may include command information of commands executed by the storage controller 100. For example, the controller management information CIN may include information on the latency sensitive command (e.g., the command ID, the remaining latency, etc.) included in the host management information HIN. The detailed structure and operation of the command management block 170 will be described in more detail with reference to FIGS. 7 and 8.

The storage device 1200 described with reference to FIG. 3 is an example and the scope of the present disclosure is not limited thereto. Although one storage controller 100 is illustrated in FIG. 3, a plurality of storage controllers identical to or similar to the storage controller 100 of FIG. 3 may be included as illustrated in FIG. 1. The configurations of the storage controller 100 in FIG. 3 are an example, and the scope of the present disclosure is not limited thereto. Embodiments in which functions of each configuration are performed by other configurations should also be understood as falling within the scope of the present disclosure. For example, one or more embodiments in which the storage controller 100 is configured to perform an operation of the physical function blocks 130, the virtual function blocks 140, or the command management block 170, or one or more embodiments including a processor implementing these functions may also fall within the scope of the present disclosure.

FIG. 4 is a block diagram illustrating how the storage controller 100 processes a command issued by the host 1100, according to one or more embodiments of the present disclosure. The storage controller 100 of FIG. 4 may be any one of the first to n-th storage controllers 1211 to 121n of FIG. 1 or may be the storage controller 100 of FIG. 3. The host 1100 may be any one of the hosts 1101 to 110n in FIG. 1 or may be the host 1100 in FIG. 2. With reference to FIG. 4, a sequence of operations in which the storage controller 100 processes a command issued by the host 1100 according to one or more embodiments of the present disclosure is described.

In operation S11, the host 1100 may issue a new command to the submission queue SQ. In one or more embodiments, the host 1100 may input the new command into the tail TAIL of the submission queue SQ. In operation S12, the host 1100 may inform the storage controller 100 that the new command is issued. For example, the host 1100 may transmit a doorbell including a new tail TAIL to a submission queue tail pointer SQTP in the doorbell register block 150.

In operation S13, the storage controller 100 may fetch a command of the head of the submission queue SQ. In one or more embodiments, the storage controller 100 may fetch at least one command including a command specified in the head HEAD of the submission queue SQ and may store them into the internal buffer block 160 of FIG. 2. For example, the storage controller 100 may fetch the plurality of commands included in the pointer of the head HEAD of the submission queue SQ and various subsequent pointers and may store them into the internal buffer block 160 of FIG. 2.

In operation S14, the storage controller 100 may execute the fetched command. In one or more embodiments, the storage controller 100 may execute a plurality of fetched commands depending on the priority. For example, the storage controller 100 may perform the operation indicated by the command (e.g., a data write operation or a data read operation). In this case, data may be exchanged between the storage controller 100 and the host 1100 through an interface port.

In operation S15, the storage controller 100 may write the response RES corresponding to the command into the tail TAIL of the completion queue CQ. For example, the storage controller 100 may write the read data corresponding to the command or the response indicating that a write operation corresponding to the command is completed into the tail TAIL of the completion queue CQ. In operation S16, the storage controller 100 may transmit an interrupt signal to the host 1100. The interrupt signal may be a pin-based interrupt signal or a message signal-based interrupt signal. The pin-based interrupt signal may be provided through a dedicated physical line or pin to notify the host 1100 of an event. The message-based interrupt signal may be provided through a communication channel or bus rather than using a dedicated pin.

In operation S17, the host 1100 may process a command completion. After completing the command, the host 1100 may move the pointer of the completion queue CQ to the subsequent pointer. In operation S18, the host 1100 may transmit the updated head HEAD pointer of the completion queue CQ to the storage controller 100. For example, the host 1100 may transmit the updated head HEAD pointer of the completion queue CQ to a completion queue head pointer CQHP of the doorbell register block 150.

From operations S11 to S18, exchange of signals or data between the host 1100 and the storage controller 100 may be performed through the port of the interface. For example, the host 1100 and the storage controller 100 may operate according to the NVMe protocol, and may exchange signals or data through ports of an interface that complies with the PCIe standard between the host 1100 and the storage controller 100.

The latency may refer to the time required for the host 1100 to issue the command in operation S11 and then to complete the command completion processing in operation S17. Some of the commands issued by the host 1100 may be latency sensitive. A latency sensitive command may be a command in which the latency of command execution is guaranteed or should be strictly controlled. For example, a command that requests data from the storage device 1200 for an operation requiring urgent processing by the host 1100 may be considered latency sensitive.

Referring to FIG. 4, the latency sensitive command may be written into the submission queue SQ. When the storage controller 100 and the host 1100 sequentially process the latency sensitive commands according to the above-described order, a problem may occur in which the latency specified for the command may not be observed. To solve this problem, the host 1100 and the storage controller 100 require a method that may prioritize the commands sensitive to the latency or a method that may process the commands sensitive to the latency within the latency limitation. In detail, a method that may guarantee the latency of commands of the storage system 1000 is required. With reference to the following drawings, the storage system 1000 in which latency sensitive commands may be processed in compliance with the latency will be described, according to one or more embodiments of the present disclosure.

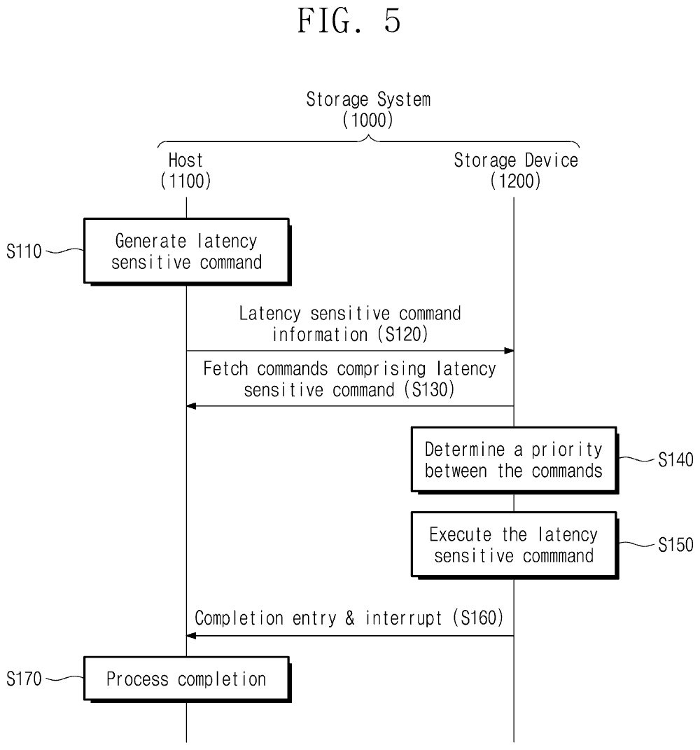

FIG. 5 is a flowchart illustrating a method of operating the storage system 1000 including the host 1100 of FIG. 2 and the storage device 1200 of FIG. 3, according to one or more embodiments of the present disclosure. With reference to FIGS. 1 to 5, a method of operating the storage system 1000 that may guarantee the latency of the latency sensitive command, according to one or more embodiments of the present disclosure, will be described.

Referring to FIGS. 1 to 5, in operation S110, the host 1100 may generate the latency sensitive command. In one or more embodiments, the host 1100 may issue the latency sensitive command to the tail TAIL of the submission queue SQ in FIG. 2. In operation S110, the host 1100 may issue the latency sensitive command, and similarly to operation S12 of FIG. 4, then may transmit a new tail TAIL pointer of the submission queue SQ to the storage controller 100.

In operation S120, the host 1100 may transmit command information of the latency sensitive command to the storage device 1200. In one or more embodiments, the host 1100 may transmit the host management information HIN including information on the latency sensitive command to the storage device 1200. For example, the host 1100 may transmit the host management information HIN including information on the latency sensitive command to the controller manager 1220. The host management information HIN may include various information such as information on the host 1100 that issues the command, the command ID of the latency sensitive command, or the latency limitation of the latency sensitive command. Information indicating whether a certain command is latency-sensitive may be predetermined and stored in the host 1100.

Although operations S110 and S120 are illustrated and described in FIG. 5 as being performed sequentially, the scope of the present disclosure is not limited thereto. One or more embodiments in which operations S110 and S120 are performed simultaneously, one or more embodiments in which at least part of operations S110 and S120 are performed simultaneously, or one or more embodiments in which operation S120 is performed before operation S110 should be understood as falling within the scope of the present disclosure.

In operation S130, the storage device 1200 may fetch commands of the host 1100. In one or more embodiments, the storage device 1200 may fetch the plurality of commands from the submission queue SQ of the host 1100. For example, the storage controller 100 of FIG. 3 may fetch the plurality of commands from the submission queue SQ and may store them into the internal buffer block 160. In one or more embodiments, the storage controller 100 may store the plurality of fetched commands in the internal buffer block 160 using any suitable data structure. For example, the storage controller 100 may store the plurality of fetched commands in the internal buffer block 160 based on a priority queue structure.

In operation S140, the storage device 1200 may determine or generate the priority between commands. In one or more embodiments, the storage device 1200 may generate an execution priority between the plurality of commands based on the host management information HIN. For example, referring to FIG. 3 together, the command management block 170 of the storage controller 100 may receive the host management information HIN from the controller manager 1220, and may determine or generate a command priority based on the host management information HIN. A more detailed operation in which the storage device 1200 determines the priority of the plurality of commands will be described with reference to FIG. 7.

In operation S150, the storage device 1200 may execute the latency sensitive command. In one or more embodiments, the storage device 1200 may execute the latency sensitive command based on the priority between commands. For example, the storage device 1200 may execute the latency sensitive command first based on the priority of the command, independently of the order specified in the submission queue SQ. For a more detailed example, the storage controller 100 may cause the latency sensitive command among at least one or more commands stored in the internal buffer block 160 according to the priority between commands generated by the command management block 170 to be processed first by the physical function blocks 130 or the virtual function blocks 140.

In operation S160, the storage device 1200 may write the execution result into the completion queue CQ and may transmit an interrupt to the host 1100. For example, the storage device 1200 may write the execution result of the latency sensitive command to the tail TAIL of the completion queue CQ and then may transmit the interrupt to the host 1100.

In operation S170, the host 1100 may complete processing on the execution result written in the completion queue CQ. For example, the host 1100 may process the execution result of the head HEAD of the completion queue CQ. Subsequently, the host 1100 may move the head HEAD pointer of the completion queue CQ to the next, and similarly to operation S18 of FIG. 4, may transmit the newly generated head HEAD pointer of the completion queue CQ to the storage device 1200.

Based on operations S110 to S170 of FIG. 5, the latency sensitive command issued by the host 1100 may be quickly processed by the storage device 1200. In operations S160 and S170 of FIG. 5, since execution results are processed in the order in which they are written to the completion queue CQ, when there are more execution results written in advance to the completion queue CQ than execution results of the latency sensitive command, there may be cases where latency is not observed. To solve this issue, a method is required in which the host 1100 prioritizes the execution results of commands that are sensitive to latency.

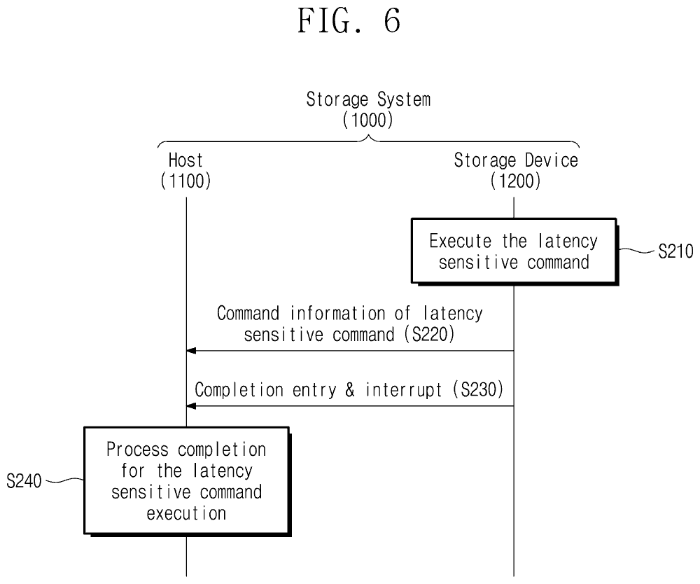

FIG. 6 is a flowchart illustrating a method of operating the storage system 1000 including the host 1100 of FIG. 2 and the storage device 1200 of FIG. 3, according to one or more embodiments of the present disclosure. With reference to FIGS. 1 to 6, one or more embodiments in which the storage system 1000 processes the latency sensitive command is described. The method of FIG. 6 may be operations performed after operation S140 of FIG. 5.

In operation S210, the storage device 1200 may execute the latency sensitive command. The storage device 1200 may execute the latency sensitive command that is the same as or similar to operation S150 of FIG. 5.

In operation S220, the storage device 1200 may transmit command information of the latency sensitive command to the host 1100. In one or more embodiments, the storage device 1200 may transmit the controller management information CIN including information on the latency sensitive command to the host 1100. For example, the controller manager 1220 may transmit the controller management information CIN including command information of the latency sensitive command to the host 1100 that issues the command. The command information may include various information such as the command ID or the remaining latency.

In operation S230, the storage device 1200 may write the execution result into the completion queue CQ and may transmit an interrupt to the host 1100. For example, the storage device 1200 may write the execution result of the latency sensitive command to the tail TAIL of the completion queue CQ and then may transmit the interrupt to the host 1100.

In FIG. 6, operations S220 and S230 are illustrated as being performed sequentially, but the scope of the present disclosure is not limited thereto. It should be understood that one or more embodiments in which operations S220 and S230 are performed simultaneously, or one or more embodiments in which operation S220 is performed after operation S230, may also fall within the scope of the present disclosure.

In operation S240, the host 1100 may process the execution result of the latency sensitive command. In one or more embodiments, the host 1100 may determine when the execution result of the latency sensitive command is processed so as to comply with the remaining latency. For example, the host 1100 may select the time to process the execution result of the latency sensitive command based on information such as the remaining latency included in the controller management information CIN received from the storage device 1200, or a pointer location (e.g., distance from the head HEAD) in the completion queue CQ of the execution result of the latency sensitive command. The host 1100 may determine whether the execution result of the latency sensitive command exists within the execution results arranged in the completion queue CQ based on the command ID of the latency sensitive command.

In one or more embodiments, the host 1100 may temporarily store previous execution results in the host buffer block 1120 to first process execution results of the latency sensitive command. For example, the host 1100 may store the execution result with the head HEAD of the completion queue CQ as a pointer or the previous execution result of the latency sensitive command into the host buffer block 1120, and then may first process the execution result of the latency sensitive command into the host buffer block 1120. Thereafter, the execution results stored in the host buffer block 1120 may be sequentially processed by the host 1100 according to the order in the completion queue CQ.

In another embodiment, the host 1100 may temporarily store at least some of the previous execution results into the host buffer block 1120 in consideration of the remaining latency, to ensure the latency of the latency sensitive command. For example, the host 1100 may store some of the previous execution results of the latency sensitive command in the host buffer block 1120. Thereafter, the host 1100 sequentially processes the execution results remaining in the completion queue CQ, so that the execution results of the latency sensitive command are processed before the remaining latency expires.

In one or more embodiments, when the host 1100 has the completion queue CQ as the priority queue, the host 1100 may change the priority of the execution results of the completion queue CQ so that the execution results of the latency sensitive command are processed before the remaining latency. For example, the host 1100 may ensure that execution results of the latency sensitive command are processed with the highest priority based on the controller management information CIN. As another example, the host 1100 may determine the priority of the execution results of the latency sensitive command such that the execution results may be processed within the remaining latency, based on the processing time of other execution results in the completion queue CQ.

Based on the operation of FIG. 6, the host 1100 may ensure that the processing results of the storage device 1200 are processed in accordance with the remaining latency. The storage system 1000 operating according to the method of FIGS. 5 and 6 may ensure that the latency sensitive commands are processed at a specified latency. In detail, the host 1100 may guarantee the latency of commands. Additionally, since the latency sensitive commands are performed before the latency limitation, the storage system 1000 may operate more smoothly.

The storage system 1000 operating according to one or more embodiments combining FIGS. 5 and 6 may also fall within the scope of the present disclosure. For example, the storage system 1000 may perform operations in operations S110 to S140 of FIG. 5 and then may perform operations in operations S220 to S240 in FIG. 6 to ensure that the latency sensitive commands are processed in compliance with the latency limitation.

Additionally, in the embodiment of FIG. 5 or the embodiment of FIG. 6, the submission queue SQ or the completion queue CQ included in the host 1100 may be the priority queue as described in FIG. 3. In this case, the host 1100 may perform a process of changing the priority of the command or the priority of the command execution result in the submission queue SQ or the completion queue CQ to ensure the latency. For example, before operation S130 of FIG. 5, the host 1100 may change the priority of the submission queue SQ such that the latency sensitive command are fetched first, and the storage device 1200 may omit operation S140.

FIG. 7 is a block diagram illustrating a command management block of FIG. 3 in detail, according to one or more embodiments of the present disclosure. A command management block 200 may correspond to the command management block 170 of FIG. 3. Referring to FIG. 7, the command management block 200 may include a controller interface circuit 210, a command control circuit 220, a latency calculation circuit 230, and a controller state circuit 240. With reference to FIGS. 1 to 7, the command management block 200 according to one or more embodiments of the present disclosure is described in detail.

The controller interface circuit 210 may enable communication between the storage controller 1210 and the controller manager 1220. In one or more embodiments, the controller interface circuit 210 may receive the host management information HIN from the controller manager 1220, or may transmit the controller management information CIN to the controller manager 1220. The controller interface circuit 210 may transmit the received host management information HIN to the command control circuit 220 or the latency calculation circuit 230. The controller interface circuit 210 may transmit the controller management information CIN generated from the latency calculation circuit 230 or the controller state circuit 240 to the controller manager 1220.

The command control circuit 220 may set the priority of commands. In one or more embodiments, the command control circuit 220 may determine the priority among a plurality of commands stored in the internal buffer block 160 of FIG. 3. In one or more embodiments, the command control circuit 220 may determine the priority among the plurality of commands based on the host management information HIN from the controller manager 1220 of FIG. 1. For example, the command control circuit 220 may set the priority among the plurality of commands including the latency sensitive command based on the host management information HIN.

In one or more embodiments, the command control circuit 220 may perform priority arbitration based on the processing order of commands in the submission queue SQ or information on the latency sensitive command. For example, the command control circuit 220 determines the priority in which the plurality of commands stored in the internal buffer block 160 of FIG. 3 are executed by the physical function blocks 130 or the virtual function blocks 140. For a more detailed example, the command control circuit 220 may adjust or determine the priority among commands listed in the internal buffer block 160.

In one or more embodiments, the command control circuit 220 may determine the priority of commands by using or applying various scheduling methods or priority adjustment methods. For example, the command control circuit 220 may determine the priority at which commands are executed based on various methods or policies, such as a preemptive method such as shortest remaining time (SRT), round-robin, multi-level queue, or multi-level feedback queue, or a non-preemptive method such as first-come-first-serve (FCFS), first in first out (FIFO), shortest job first scheduling (SJF), or highest response ratio next (HRN). In one or more embodiments, the policy used by the command control circuit 220 to determine the priority may be selected based on command information included in the host management information HIN.

The latency calculation circuit 230 may calculate a latency of a command or an execution time of a command. In one or more embodiments, the latency calculation circuit 230 may calculate the command execution time or the remaining latency based on the host management information HIN. For example, the latency calculation circuit 230 may calculate the execution time of the command based on a difference between the time of issuing the command included in the host management information HIN and the time when the storage controller 100 writes the execution result to the completion queue CQ. As another example, the latency calculation circuit 230 may calculate the remaining latency of the command based on the latency limitation of the command in the host management information HIN and the difference between the processing times of the command.

In one or more embodiments, the latency calculation circuit 230 may calculate the command processing time associated with the latency sensitive command or the remaining latency of the command. The host 1100 may determine the order in which execution results of the completion queue CQ will be processed based on the remaining latency of the command calculated by the latency calculation circuit 230. The latency calculation circuit 230 may transmit the remaining latency of the generated command to the controller manager 1220 through the controller interface circuit 210 in the form of controller management information CIN. The controller management information CIN transferred to the controller manager 1220 may be transmitted to the host 1200 that issues the command (or the host that transmits the host management information HIN to the controller manager 1220).

The controller state circuit 240 may generate controller status information. For example, the controller state circuit 240 may generate the controller status information such as overall status, such as a power consumption amount, an error occurrence, etc. of the storage controller 100, or the controller status information such as performance of the storage controller 100. The controller status information generated by the controller state circuit 240 may be transmitted to the corresponding host 1100 via the controller manager 1220 through the controller management information CIN. The host 1100 may manage the corresponding storage controller 100 to operate stably based on the controller status information.

Although FIG. 7 illustrates that the controller state circuit 240 is included in the command management block 200, the scope of the present disclosure is not limited thereto. For example, one or more embodiments in which the controller state circuit 240 is included in the storage controller 100 and not included in the command management block 200, or one or more embodiments in which the function is implemented by a processor in the storage controller 100 should also be understood to fall within the scope of the present disclosure. The division between the command management circuit 220 and the latency management circuit 230 illustrated and described in FIG. 7 may be a functional distinction. For example, one or more embodiments in which the command management block 200 includes a processor that performs the operations of the command management circuit 220 or the latency management circuit 230 should also be understood to fall within the scope of the present disclosure.

FIG. 8 is a block diagram illustrating how a command management block of FIG. 7 operates, according to one or more embodiments of the present disclosure. With reference to FIGS. 1 to 7, an operation or method by which the command management block 200 determines the priority of commands and calculates the remaining latency of the commands is described.

Referring to FIGS. 1 to 8, in operation S310, the controller interface circuit 210 may receive command information of the latency sensitive command from the controller manager 1220. In one or more embodiments, the controller interface circuit 210 may receive the command information of the latency sensitive command in the form of the host management information HIN. For example, the controller interface circuit 210 may receive the host management information HIN including the issuance time, the ID, and the latency limitation of the latency sensitive command from the controller manager 1220. Although the controller interface circuit 210 is described as receiving information about the latency sensitive command from the command manager 1220, the present embodiment is not limited thereto, and any type of command should also be understood to fall within the scope of embodiments of the present disclosure.

In operation S320, the controller interface circuit 210 may transmit the command information associated with the latency sensitive command to the command control circuit 220 and the latency calculation circuit 230. In one or more embodiments, the controller interface circuit 210 may transmit the host management information HIN including the command information associated with the latency sensitive command to the command control circuit 220 and the latency calculation circuit 230.

In operation S330, the command management circuit 220 may generate the priority among the plurality of commands. In one or more embodiments, the command management circuit 220 may generate priorities among commands stored in the internal buffer block 160 based on various information including the host management information HIN. For example, the command management circuit 220 may determine the priority between the plurality of commands based on the order of commands in the submission queue SQ and the command information of the latency sensitive commands included in the host management information HIN. In detail, the command management circuit 220 may set priorities among commands based on various information such that the latency sensitive commands may comply with the latency limitation. For example, the command management circuit 220 may set priorities of the plurality of commands by applying various techniques described in FIG. 7.

In operation S340, function blocks FB may be part of a processor and may execute commands based on the priority generated in operation S330. The function blocks FB may correspond to the physical function blocks 130 or the virtual function blocks 140 of FIG. 3. In one or more embodiments, the function blocks FB may execute the plurality of commands stored in the internal buffer block 160 of FIG. 3 depending on the priority. For example, the function blocks FB may execute the latency sensitive command based on the priority of the commands such that the latency limitation of the latency sensitive command is maintained.

In operation S350, the function blocks FB may notify the latency calculation circuit 230 that execution of the command is completed. In one or more embodiments, when the execution of the latency sensitive command is completed, the function blocks FB may notify the latency calculation circuit 230 that execution of the latency sensitive command is completed. In this case, the function blocks FB may write the execution result of the command into the completion queue CQ of FIGS. 2 and 4.

In operation S360, the latency calculation circuit 230 may calculate the remaining latency of the command. In one or more embodiments, the latency calculation circuit 230 may calculate the remaining latency of the latency sensitive command. In one or more embodiments, the latency calculation circuit 230 may calculate the remaining latency based on the host management information HIN transferred from the controller interface circuit 210 and the completion of command execution. For example, the latency calculation circuit 230 may calculate the remaining latency of the latency sensitive command based on the latency limitation of the latency sensitive command, the time when the latency sensitive command is completed, and the time when the host 1100 issues the latency sensitive command.

In one or more embodiments, the latency calculation circuit 230 may calculate the remaining latency of the command further based on the transmission time from the latency calculation circuit 230 to the host 1100. For example, in the latency limitation of the latency sensitive command, the latency calculation circuit 230 may generate the remaining latency of the latency sensitive command excluding the difference between the time when the host 1100 issues the command and the time when the function blocks FB execute the command and write it into the completion queue CQ, and the time it takes to transfer from the latency calculation circuit 230 to the host 1100 (e.g., via the controller interface circuit 210 and the controller manager 1220). The remaining latency may be used to determine the time when the host 1100 will process the execution results of the completion queue CQ.

In operation S370, the latency calculation circuit 230 may transfer the remaining latency to the controller interface circuit 210. In one or more embodiments, the latency calculation circuit 230 may transfer the remaining latency of the latency sensitive command to the controller interface circuit 210. In one or more embodiments, the remaining latency generated by the latency calculation circuit 230 may be transferred to the controller interface circuit 210 in the form of the controller management information CIN.

In operation S380, the controller interface circuit 210 may transmit the information of the latency sensitive command to the command manager 1220. In one or more embodiments, the controller interface circuit 210 may transmit the information of the latency sensitive command to the command manager 1220 through the controller management information CIN. In one or more embodiments, the controller management information CIN transmitted to the controller manager 1220 by the controller interface circuit 210 may include various information such as information about the command (e.g., the host that issues the command, the command ID, or the remaining latency, etc.) and the controller status information. Although the controller interface circuit 210 is described as transmitting information about the latency sensitive command to the command manager 1220, the present disclosure is not limited thereto. Any type of command information for an arbitrary command is transmitted should also be understood to fall within the scope of embodiments of the present disclosure.

Based on the method described with reference to FIG. 8, the storage device 1200 may enable that the latency of the command issued by the host 1100 is guaranteed. This may enable the storage system 1000 to operate stably in cases where guaranteed latency is essential (e.g., when it is directly related to safety).

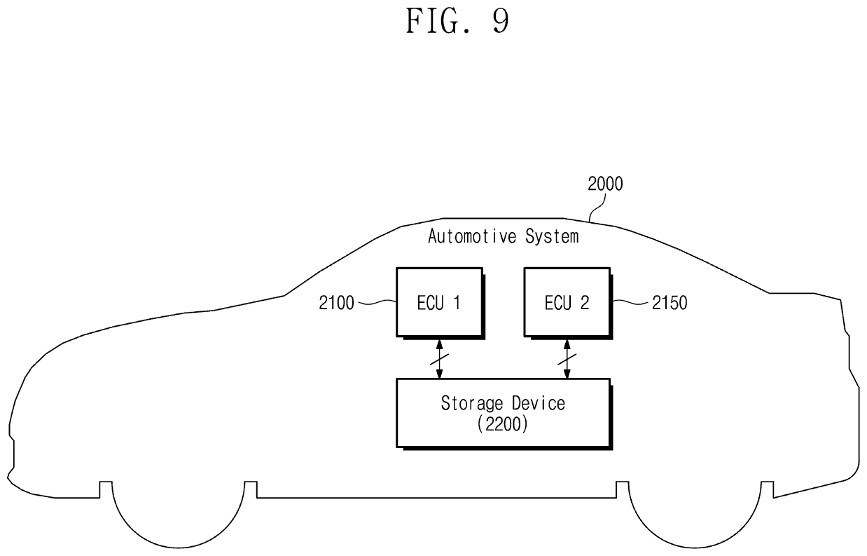

FIG. 9 is a diagram illustrating an automotive system 2000, according to one or more embodiments of the present disclosure. Referring to FIG. 9, the automotive system 2000 may include a first electronic control unit (ECU) 2100, a second ECU 2150, and a storage device 2200. With reference to FIG. 9, the automotive system 2000 according to one or more embodiments of the present disclosure is described.

The automotive system 2000 may be a system that includes an engine or a motor, such as a vehicle, and may be configured to perform various operations. For example, the automotive system 2000 may be a system that is included in various types of vehicles, such as passenger cars, commercial vehicles, military vehicles, or special vehicles, and allows the vehicle to perform various operations.

The first ECU 2100 and the second ECU 2150 may control the operation of the automotive system 2000. In one or more embodiments, the first ECU 2100 and the second ECU 2150 may correspond to the host 1100 described with reference to FIGS. 1 and 2. In one or more embodiments, the first ECU 2100 and the second ECU 2150 may operate independently and may perform separate functions. For example, the first ECU 2100 may control acceleration of vehicles, and the second ECU 2150 may control deceleration of vehicles or control brake lights. For example, each of the first ECU 2100 and the second ECU 2150 may be or may include at least part of an engine control unit (ECU), a panel controller, a transmission control unit (TCU), a powertrain control module (PCM), an electronic stability control (ESC), an airbag controller, a tire pressure monitoring system (TPMS), an anti-lock braking system (ABS), etc., or may perform operations similar to them. The first ECU 2100 and the second ECU 2150 may share the storage device 2200.

The first ECU 2100 and the second ECU 2150 may comply with standards related to automotive specifications. In one or more embodiments, the first ECU 2100 and the second ECU 2150 may comply with ISO 26262. In one or more embodiments, the first ECU 2100 and the second ECU 2150 may have a safety rating according to a standard. For example, the first ECU 2100 and the second ECU 2150 may have one of safety grades or standards such as an automotive safety integrity level D (ASIL D), an ASIL C, an ASIL B, an ASIL A, or a quality management (QM). In the ASIL, the ASIL D is the highest level of security required, and may be lowered sequentially to the ASIL C, the ASIL B, and the ASIL A.

The storage device 2200 may be a shared storage device. For example, the storage device 2200 may be shared by the first ECU 2100 and the second ECU 2150. In one or more embodiments, the storage device 2200 may correspond to the storage device 1200 described with reference to FIGS. 1 and 3 to 8.

In one or more embodiments, the first ECU 2100 and the second ECU 2150 may not include a management port, depending on the safety grades. In detail, the first ECU 2100 and the second ECU 2150 may be connected to the controller manager 1220 based on the NVMe-MI protocol according to the safety grades. For example, when the first ECU 2100 and the second ECU 2150 have the QM grade, they may not be connected to the controller manager 1220, and when the first ECU 2100 and the second ECU 2150 have the ASIL grade, they may be connected to the controller manager 1220 to transmit the host management information HIN.

Although the automotive system 2000 is illustrated in FIG. 9 as including the first ECU 2100 and the second ECU 2150, the scope of the present disclosure is not limited thereto. In one or more embodiments, the automotive system 2000 may include additional electronic devices such as an electronic control unit (ECU) or a processor that share the storage device 2200. The automotive system 2000 of FIG. 9 may include the storage system 1000 described with reference to FIGS. 1 to 8 and may enable that the latency of the latency sensitive command issued by the first ECU 2100 or the second ECU 2150 according to the safety grade is guaranteed.

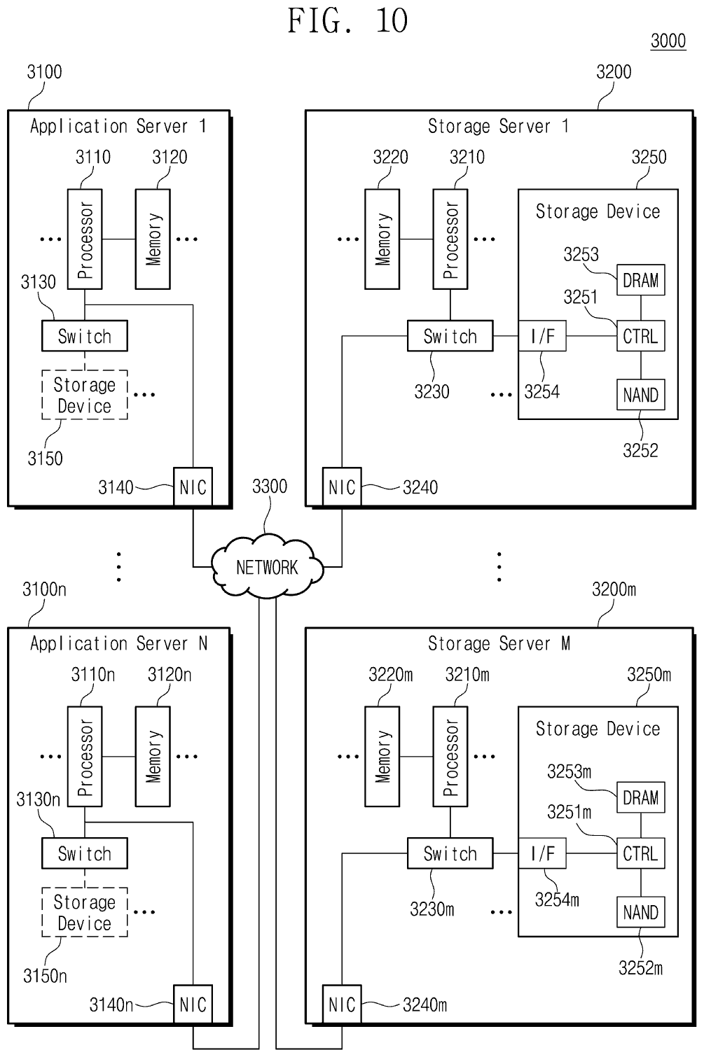

FIG. 10 is a diagram of a data center 3000 to which a memory device is applied, according to one or more embodiments. Referring to FIG. 10, the data center 3000 may be a facility that collects various types of pieces of data and provides services and be referred to as a data storage center. The data center 3000 may be a system for operating a search engine and a database, and may be a computing system used by companies, such as banks, or government agencies. The data center 3000 may include application servers 3100 to 3100n and storage servers 3200 to 3200m. The number of application servers 3100 to 3100n and the number of storage servers 3200 to 3200m may be variously selected according to embodiments. The number of application servers 3100 to 3100n may be different from the number of storage servers 3200 to 3200m.

In one or more embodiments, the application server 3100 may be or include the host 1100 described in FIGS. 1, 2, and 4 to 8. In one or more embodiments, the storage server 3200 may be or include the storage device 1200 described in FIGS. 1, and 3 to 8. In one or more embodiments, the storage servers 3200 to 3200m may be shared by two or more application servers 3100 to 3100n. In and embodiment, some or all application servers 3100 to 3100n may transmit the host management information HIN of FIG. 1 to storage servers 3200 to 3200m, or receive the controller management information CIN from the storage servers 3200 to 3200m, based on a separate interface (e. g., sideband interface) other than NIC 3140. The application servers 3100 to 3100n and the storage servers 3200 to 3200m may ensure the latency of the latency sensitive command issued by the application servers 3100 to 3100n, based on the operations of host 1100 and storage device described in FIGS. 1 to 8.

The application server 3100 or the storage server 3200 may include at least one of processors 3110 and 3210 and memories 3120 and 3220. The storage server 3200 will now be described as an example. The processor 3210 may control all operations of the storage server 3200, access the memory 3220, and execute instructions and/or data loaded in the memory 3220. The memory 3220 may be a double-data-rate synchronous DRAM (DDR SDRAM), a high-bandwidth memory (HBM), a hybrid memory cube (HMC), a dual in-line memory module (DIMM), Optane DIMM, and/or a non-volatile DIMM (NVMDIMM). In some embodiments, the numbers of processors 3210 and memories 3220 included in the storage server 3200 may be variously selected. In one or more embodiments, the processor 3210 and the memory 3220 may provide a processor-memory pair. In one or more embodiments, the number of processors 3210 may be different from the number of memories 3220. The processor 3210 may include a single-core processor or a multi-core processor. The above description of the storage server 3200 may be similarly applied to the application server 3100. In some embodiments, the application server 3100 may not include a storage device 3150. The storage server 3200 may include at least one storage device 3250. The number of storage devices 3250 included in the storage server 3200 may be variously selected according to embodiments.

The application servers 3100 to 3100n may communicate with the storage servers 3200 to 3200m through a network 3300. The network 3300 may be implemented by using a fiber channel (FC) or Ethernet. In this case, the FC may be a medium used for relatively high-speed data transmission and use an optical switch with high performance and high availability. The storage servers 3200 to 3200m may be provided as file storages, block storages, or object storages according to an access method of the network 3300.

In one or more embodiments, the network 3300 may be a storage-dedicated network, such as a storage area network (SAN). For example, the SAN may be an FC-SAN, which uses an FC network and is implemented according to an FC protocol (FCP). As another example, the SAN may be an Internet protocol (IP)-SAN, which uses a transmission control protocol (TCP)/IP network and is implemented according to a SCSI over TCP/IP or Internet SCSI (iSCSI) protocol. In another embodiment, the network 3300 may be a general network, such as a TCP/IP network. For example, the network 3300 may be implemented according to a protocol, such as FC over Ethernet (FCOE), network attached storage (NAS), and NVMe over Fabrics (NVMe-oF).

Hereinafter, the application server 3100 and the storage server 3200 will mainly be described. A description of the application server 3100 may be applied to another application server 3100n, and a description of the storage server 3200 may be applied to another storage server 3200m.

The application server 3100 may store data, which is requested by a user or a client to be stored, in one of the storage servers 3200 to 3200m through the network 3300. Also, the application server 3100 may obtain data, which is requested by the user or the client to be read, from one of the storage servers 3200 to 3200m through the network 3300. For example, the application server 3100 may be implemented as a web server or a database management system (DBMS).

The application server 3100 may include a processor 3110, a memory 3120, a switch 3130, a Network InterConnect (NIC) 3140, and a storage device 3150. The switch 3130 may selectively connect the processor 3110 to the storage device 3150 or to the NIC 3140. The application server 3100 may access a memory 3120n or a storage device 3150n, which is included in another application server 3100n, through the network 3300. Alternatively, the application server 3100 may access memories 3220 to 3220m or storage devices 3250 to 3250m, which are included in the storage servers 3200 to 3200m, through the network 3300. Thus, the application server 3100 may perform various operations on data stored in application servers 3100 to 3100n and/or the storage servers 3200 to 3200m. For example, the application server 3100 may execute an instruction for moving or copying data between the application servers 3100 to 3100n and/or the storage servers 3200 to 3200m. In this case, the data may be moved from the storage devices 3250 to 3250m of the storage servers 3200 to 3200m to the memories 3120 to 3120n of the application servers 3100 to 3100n directly or through the memories 3220 to 3220m of the storage servers 3200 to 3200m. The data moved through the network 3300 may be data encrypted for security or privacy.

The storage server 3200 will now be described as an example. An interface 3254 may provide physical connection between a processor 3210 and a controller 3251 and a physical connection between a network interface card (NIC) 3240 and the controller 3251. For example, the interface 3254 may be implemented using a direct attached storage (DAS) scheme in which the storage device 3250 is directly connected with a dedicated cable. For example, the interface 3254 may be implemented by using various interface schemes, such as ATA, SATA, e-SATA, an SCSI, SAS, PCI, PCIe, NVMe, IEEE 1394, a USB interface, an SD card interface, an MMC interface, an eMMC interface, a UFS interface, an eUFS interface, and/or a CF card interface.

The storage server 3200 may further include a switch 3230 and the NIC 3240. The switch 3230 may selectively connect the processor 3210 to the storage device 3250 or to the storage device 3250 via the control of the processor 3210.

In one or more embodiments, the NIC 3240 may include a network interface card and a network adaptor. The NIC 3240 may be connected to the network 3300 by a wired interface, a wireless interface, a Bluetooth interface, or an optical interface. The NIC 3240 may include an internal memory, a digital signal processor (DSP), and a host bus interface and be connected to the processor 3210 and/or the switch 3230 through the host bus interface. The host bus interface may be implemented as one of the above-described examples of the interface 3254. In one or more embodiments, the NIC 3240 may be integrated with at least one of the processor 3210, the switch 3230, and the storage device 3250.

In the storage servers 3200 to 3200m or the application servers 3100 to 3100n, a processor may transmit a command to storage devices 3150 to 3150n and 3250 to 3250m or the memories 3120 to 3120n and 3220 to 3220m and program or read data. In this case, the data may be data of which an error is corrected by an ECC engine. The data may be data on which a data bus inversion (DBI) operation or a data masking (DM) operation is performed, and may include cyclic redundancy code (CRC) information. The data may be data encrypted for security or privacy.

Storage devices 3150 to 3150n and 3250 to 3250m may transmit a control signal and a command/address signal to NAND flash memory devices 3252 to 3252m in response to a read command received from the processor. Thus, when data is read from the NAND flash memory devices 3252 to 3252m, a read enable (RE) signal may be input as a data output control signal, and thus, the data may be output to a DQ bus. A data strobe signal DQS may be generated using the RE signal. The command and the address signal may be latched in a page buffer depending on a rising edge or falling edge of a write enable (WE) signal.

The controller 3251 may control all operations of the storage device 3250. In one or more embodiments, the controller 3251 may include SRAM. The controller 3251 may write data to the NAND flash memory device 3252 in response to a write command or read data from the NAND flash memory device 3252 in response to a read command. For example, the write command and/or the read command may be provided from the processor 3210 of the storage server 3200, the processor 3210m of another storage server 3200m, or the processors 3110 and 3110n of the application servers 3100 and 3100n. DRAM 3253 may temporarily store (or buffer) data to be written to the NAND flash memory device 3252 or data read from the NAND flash memory device 3252. Also, the DRAM 3253 may store metadata. Here, the metadata may be user data or data generated by the controller 3251 to manage the NAND flash memory device 3252. The storage device 3250 may include a secure element (SE) for security or privacy.

According to one or more embodiments of the present disclosure, a storage device capable of processing the latency sensitive command while complying with a set latency, a system including the storage device, and a method of operating the same are provided.

The above description refers to embodiments for carrying out the present disclosure. Embodiments in which a design is changed simply or which are easily changed may be included in the present disclosure as well as the above-described embodiments. In addition, technologies that are easily changed and implemented by using the above embodiments may be included in the present disclosure. Therefore, the scope of the present disclosure should not be limited to the above-described embodiments, but should be defined those equivalent to the claims of the present disclosure as well as the claims described later.

1. A method of operating a storage device comprising a first storage controller and a controller manager, the method comprising:
receiving a first command from a first host through a first port connected to the first storage controller configured to store data of the first host;
receiving first information associated with the first command from the first host through a second port connected to the controller manager configured to manage the first storage controller;
determining a priority of the first command among a plurality of commands; and
executing the first command based on the priority.

2. The method of claim 1, wherein the first host is connected to the first storage controller through a first interface, and
wherein the controller manager is connected to the first host through a second interface.

3. The method of claim 1, wherein the first information comprises a latency limitation of the first command, and a command ID of the first command.

4. The method of claim 1, wherein the plurality of commands are fetched by the first storage controller, and the priority is determined by the first storage controller.

5. The method of claim 4, wherein the plurality of commands are fetched to an internal buffer block of the first storage controller, and
wherein the priority of the plurality of commands is determined based on the first information by a command management block configured to manage the priority of the plurality of commands.

6. The method of claim 5, wherein the command management block comprises:
a command control circuit configured to determine the priority of the plurality of commands based on the first information; and
a latency calculation circuit configured to calculate remaining latency of the plurality of commands.

7. The method of claim 5, further comprising calculating a remaining latency of the first command while the first command is executed.

8. The method of claim 7, further comprising:
transmitting second information comprising the remaining latency of the first command to the first host; and
transmitting an execution result of the first command to the first host,
wherein the second information further comprises controller status information of the first storage controller.

9. The method of claim 8, wherein the controller status information comprises power consumption amount of the first storage controller, performance of the first storage controller, and a status of the first storage controller.

10. The method of claim 8, wherein the execution result of the first command is transmitted to the first host through the first port, and
wherein the second information is transmitted to the first host through the second port.

11. The method of claim 10, wherein the first information is received based on a non-volatile memory express-management interface (NVMe-MI) standard, and
wherein the second information is transmitted based on the NVMe-MI standard.

12. A method of operating a host configured to store data in a storage device, the method comprising:
writing a first command into a submission queue;
transmitting the first command to the storage device through a first port;
transmitting first information associated with the first command to the storage device through a second port;
receiving a first execution result of the first command from the storage device;
receiving second information associated with the first execution result from the storage device through the second port; and
processing the first execution result based on the second information,
wherein the second port is connected to a controller manager configured to manage at least one storage controller in the storage device.

13. The method of claim 12, wherein the first information comprises a command ID of the first command and a latency limitation of the first command, and
wherein the second information comprises the command ID of the first command and remaining latency.

14. The method of claim 13, wherein a processing time of the first execution result is determined based on the remaining latency.

15. The method of claim 13, wherein the first execution result is written to a completion queue included in the host, and
wherein the first execution result is processed to comply with the latency limitation of the first command, based on the remaining latency.

16. The method of claim 13, wherein the first execution result is received through the first port,
wherein the first port and the storage device are connected through a first interface, and
wherein the second port and the controller manager are connected through a second interface.

17. A storage device configured to store data of at least one host, the storage device comprising:
at least one non-volatile memory device configured to store data;
at least one storage controller configured to control the at least one non-volatile memory device and receive a first command and data from a first host through a first port; and
a controller manager configured to manage the storage controller and receive first information associated with the first command through a second port.

18. The storage device of claim 17, wherein the storage controller is configured to determine a priority of execution between a plurality of commands including the first command based on the first information.

19. The storage device of claim 17, wherein the storage controller includes:
function blocks configured to execute the first command;
a host interface block configured to communicate with the at least one host; and
a command management block configured to determine a priority of a plurality of commands comprising the first command based on the first information received from the controller manager.

20. The storage device of claim 18, wherein the first information comprises:
information on the first host which issues the first command; and
a latency limitation of the first command.

21-23. (canceled)
